(19) United States
(12) Patent Application Publication
(10) Pub. No.: US 2022/0012567 A1
(43) Pub. Date: Jan. 13, 2022

(54) TRAINING NEURAL NETWORK CLASSIFIERS USING CLASSIFICATION METADATA FROM OTHER ML CLASSIFIERS

(71) Applicant: VMware, Inc., Palo Alto, CA (US)

(72) Inventors: Yaniv Ben-Itzhak, Afek (IL); Shay Vargaftik, Nazareth-Illit (IL)

(21) Appl. No.: 16/924,015

(22) Filed: Jul. 8, 2020

(51) Int. Cl. G06N 3/04; G06K 9/62; G06N 20/00

(52) U.S. Cl. CPC G06N 3/0445; G06K 9/6215; G06N 20/00; G06K 9/6282; G06K 9/6256

(57) ABSTRACT

Techniques for training a neural network classifier using classification metadata from another, non-neural network (non-NN) classifier are provided. In one set of embodiments, a computer system can train the non-NN classifier using a training data set, where the training results in a trained version of the non-NN network classifier. The computer system can further classify a data instance in the plurality of data instances using the trained non-NN classifier, the classifying generating a first class distribution for the data instance, and provide the data instance's feature set as input to a neural network classifier, the providing causing the neural network classifier to generate a second class distribution for the data instance. The computer system can then compute a loss value indicating a degree of divergence between the first and second class distributions and provide the loss value as feedback to the neural network classifier, which can cause the neural network classifier to adjust one or more internal edge weights in an manner that reduces the degree of divergence.

### BACKGROUND

In machine learning (ML), classification is the task of predicting, from among a plurality of predefined categories (i.e., classes), the class to which a given data instance belongs. An ML model that implements classification is referred to as an ML classifier. Examples of well-known types of supervised ML classifiers include random forest, adaptive boosting, and gradient boosting, and an example of a well-known type of unsupervised ML classifier is isolation forest.

Neural network classifiers, which rely on a network of nodes (i.e., neurons) that are organized in layers, exhibit a number of important benefits over other types of ML classifiers, such as relatively small model size and low classification latency/high classification throughput. However, neural network classifiers also suffer from long training time, sensitivity to over-fitting, and the need for a large amount of training data in order to achieve reasonable accuracy. Accordingly, it would be useful to have techniques that can mitigate or eliminate some of these drawbacks.

### BRIEF DESCRIPTION OF THE DRAWINGS

FIG. 1 depicts a conventional training process for a neural network classifier.

FIG. 2 depicts a process for training a neural network classifier using classification metadata from a non-neural network classifier according to certain embodiments.

FIG. 3 depicts a first workflow of the training process of FIG. 2 according to certain embodiments.

FIG. 4 depicts a second workflow of the training process of FIG. 2 that includes generating new training data instances according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details or can be practiced with modifications or equivalents thereof.

### 1. Overview

Embodiments of the present disclosure are directed to techniques for training a neural network classifier (e.g., M₁) using classification metadata generated by another, different type of ML classifier (e.g., M₂), referred to herein as a non-neural network or “non-NN” classifier. Such non-NN classifiers can include, e.g., random forest classifiers, adaptive boosting classifiers, gradient boosting classifiers, and/or any other type of ML classifier that does not rely on a neural network to implement the classification task.

At a high level, the techniques of the present disclosure involve training non-NN classifier M₂ using a training data set to generate a trained version of M₂ and classifying each data instance in the training data set via trained M₂ to obtain classification metadata for the data instance. In various embodiments, this classification metadata can include a class distribution comprising, for each possible class, a probability value determined by trained M₂ which indicates the likelihood that the data instance belongs to that class.

Upon classifying the training data set via trained non-NN classifier M₂ and obtaining corresponding classification metadata, the training data set can be used to train neural network classifier M₁. However, rather than training M₁ towards outputting the labeled class for each training data instance, M₁ can be trained towards generating the class distribution generated by trained non-NN classifier M₂ for that data instance (as reflected in the data instance's classification metadata). Accordingly, with this approach, neural network classifier M₁ can be tuned to effectively mimic the classification behavior of trained non-NN classifier M₂, which in turn can enable M₁ to overcome some of the limitations/deficiencies of traditional neural network classifiers (e.g., sensitivity to over-fitting, poor performance with small/imbalanced training data sets, etc.) while maintaining their inherent advantages.

The foregoing and other aspects of the present disclosure are described in further detail in the sections that follow.

### 2. High-Level Solution Description

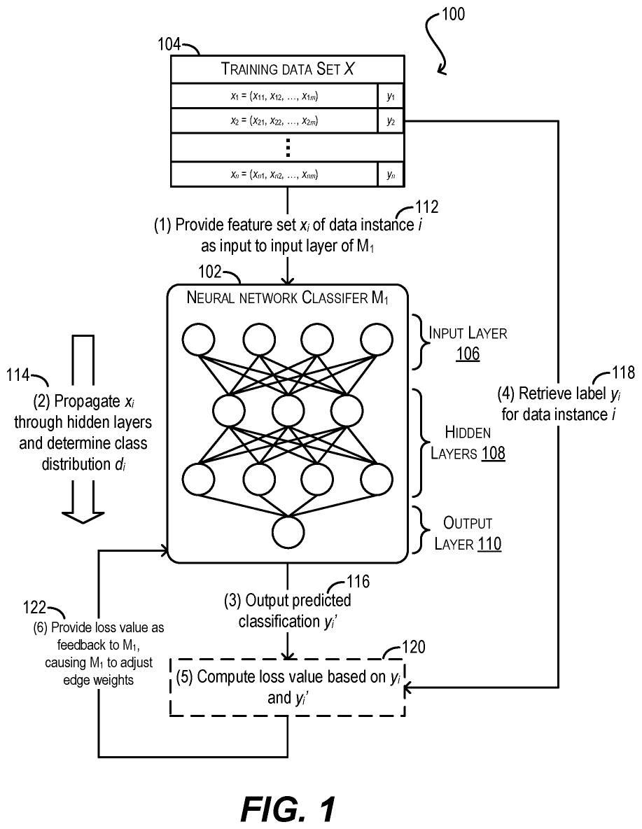

To provide context for the embodiments presented herein, FIG. 1 depicts a conventional process 100 for training a neural network classifier M₁ (reference numeral 102) using a training data set X (reference numeral 104). As shown, training data set X comprises n data instances where each data instance i (for i=1 . . . n) includes a feature set xᵢ comprising m features (xᵢ₁, xᵢ₂, . . . , xᵢₘ) and a label yᵢ indicating the correct class for feature set xᵢ. In addition, neural network classifier M₁ comprises a plurality of nodes/neurons that are organized into an input layer 106, a number of hidden layers 108, and an output layer 110. These various layers are interconnected via network edges that are each associated with a weight (not shown).

Starting with step (1) of training process 100 (reference numeral 112), feature set xᵢ for a given data instance i of X is provided as input to input layer 106 of neural network classifier M₁. At step (2) (reference numeral 114), xᵢ is propagated through hidden layers 108 and, as part of this step, a class distribution dᵢ is determined that includes, for each possible class for data instance i, a probability value indicating the likelihood that data instance i belongs to that class. For example, if there are k total classes, class distribution dᵢ can take the form (p₁, p₂, . . . , pₖ) where pⱼ (for j=1 . . . k) indicates the likelihood determined by M₁ that data instance i belongs to class j.

At step (3) (reference numeral 116), neural network classifier M₁ outputs a predicted classification yᵢ′ for data instance i at output layer 110. This predicted classification corresponds to the top-1 class in class distribution dᵢ (i.e., the class with the highest probability value). Upon outputting yᵢ′, the correct label for data instance i (i.e., yᵢ) is retrieved from training data set X (step (4); reference numeral 118) and a “loss” value is computed that indicates the degree of divergence between predicted classification yᵢ′ and correct label yᵢ (step (5); reference numeral 120).

Finally, at step (6) (reference numeral 122), the computed loss value is provided as feedback to neural network classifier M₁ and the weights of its network edges are adjusted in a manner that reduces the divergence between yᵢ′ and yᵢ. In this way, neural network classifier M₁ is trained towards outputting correct label yᵢ for input feature set xᵢ. The foregoing process is subsequently repeated until all of the data instances in training set X have been processed or until neural network classifier M₁ is considered to be sufficiently trained.

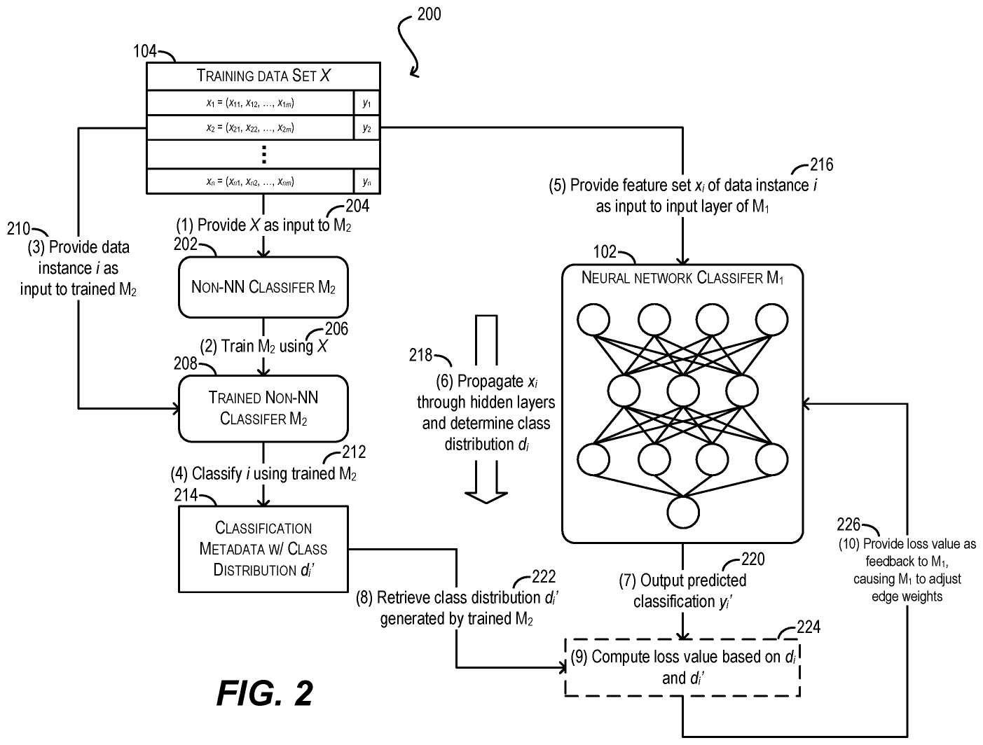

As noted in the Background section, while neural network classifiers have several advantages over other types of ML classifiers, they also suffer from a number of drawbacks such as sensitivity to over-fitting and poor performance with small or imbalanced training data sets. To address this, FIG. 2 depicts a novel process 200 for training neural network classifier M₁ of FIG. 1 that involves leveraging classification metadata generated by a different, non-NN classifier M₂ (reference numeral 202) according to certain embodiments.

Starting with step (1) of training process 200 (reference numeral 204), training data set X is provided as input to non-NN classifier M₂. As mentioned previously, non-NN classifier M₂ may be a random forest classifier, a boosting method classifier, or any other type of ML classifier that does not rely on a neural network for classification.

At step (2) (reference numeral 206), non-NN classifier M₂ is trained using training data set X, resulting in a trained version of M₂ (reference numeral 208). A given data instance i of training data set X is then provided as input to trained non-NN classifier M₂ (step (3); reference numeral 210) and trained M₂ classifies data instance i (step (4); reference numeral 212), thereby generating classification metadata that includes a class distribution dᵢ′ indicating the per-class probabilities predicted by trained M₂ for i (reference numeral 214). For example, if there are k total classes, class distribution dᵢ′ can take the form (p₁′, p₂′, . . . , pₖ′) where pⱼ′ (for j=1 . . . k) indicates the likelihood predicted by trained M₂ that data instance i belongs to class j.

Potentially concurrently with steps (3) and (4), feature set xᵢ of data instance i is provided as input to input layer 106 of neural network classifier M₁ (step (5); reference numeral 216). In response, neural network classifier M₁ propagates xᵢ through hidden layers 108 (thereby determining a class distribution dᵢ for xᵢ as described with respect to FIG. 1) (step (6); reference numeral 218) and outputs a predicted classification _{yi}′ for data instance i at output layer 110 (step (7); reference numeral 220).

Then, at steps (8) and (9) (reference numerals 222 and 224), class distribution dᵢ′ previously generated by trained non-NN classifier M₂ at step (4) is retrieved and a loss value is computed that indicates the degree of divergence between dᵢ′ and class distribution dᵢ determined by neural network classifier M₁ at step (6). Note that this is different from conventional training process 100 because the classification metadata (i.e., class distribution dᵢ′) output by non-NN classifier M₂ (rather than label yᵢ from training data set X) is used to compute the loss value. In one set of embodiments, the computation at step (9) can involve calculating a loss function (e.g., mean squared error) or distance metric (e.g., norm) between dᵢ′ and dᵢ.

Finally, at step (10) (reference numeral 226), the computed loss value is provided as feedback to neural network classifier M₁ and the weights of its network edges are adjusted to reduce the divergence between dᵢ′ and dᵢ, thereby training M₁ towards obtaining the same class distribution as trained non-NN classifier M₂. Steps (3) through (10) are subsequently repeated until all of the data instances in training set X have been processed or until neural network classifier M₁ is considered to be sufficiently trained.

With the training process shown in FIG. 2, neural network classifier M₁ is trained to mimic the classification behavior of non-NN classifier M₂ because M₁ is trained to generate the same class distributions as M₂. This enables neural network classifier M₁ to incorporate certain attributes/properties of both types of classifiers, which (depending on the type of non-NN classifier M₂) can advantageously result in an improvement in M₁'s classification performance and/or other metrics.

By way of example, Table 1 below presents various types of classification model properties (e.g., training time, model size, classification time, tendency to over-fit, sensitivity to small/imbalanced training data sets) and how these properties are manifest by (1) a conventionally-trained neural network classifier, (2) a random forest (RF) classifier, and (3) a neural network classifier than has been trained to mimic the behavior of an RF classifier per training process 200 of FIG. 2.

TABLE 1

| | (1) Convention- | | (3) Neural network |
|---|---|---|---|
| | ally-trained | (2) Random | classifier trained |
| | neural network | forest | to mimic random |
| Property | classifier | classifier | forest classifier |
| Training time | Slow | Faster | Slow |
| Model size | Small | Larger | Small |
| Classification | Fast | Slower | Fast |
| time | | | |
| Tendency to | Yes | No | No |
| over-fit | | | |
| Sensitivity to | Yes | No | No |
| small/imbalanced | | | |
| training data sets | | | |

As can be seen above, the conventionally-trained neural network classifier (i.e., (1)) and the RF classifier (i.e., (2)) exhibit opposing strengths and weaknesses with regard to each property (e.g., (1) has a small model size while (2) typically has a larger model size, (1) is prone to over-fitting while (2) is resilient to over-fitting, (1) performs poorly with small/imbalanced training data sets while (2) performs well with such training data sets, and so on). However, the neural network classifier that has been trained to mimic the RF classifier (i.e., (3)) largely incorporates the strengths of both (1) and (2), resulting in a significantly improved classifier that can work well in a variety of use cases/applications where either (1) or (2) would not.

As a concrete example, consider a use case in which the training data set available for training a classifier is relatively small, and at the same time the model size of the classifier cannot exceed a relatively low limit due to memory constraints. In this scenario, a conventionally-trained neural network classifier would not work well because it would perform poorly due to the small amount of training data. Similarly, an RF classifier would not work well because it would likely be too large to fit in memory. But, by training a neural network classifier to behave like an RF classifier per training process 200 of FIG. 2, the resulting classifier will have properties (i.e., small model size and good classification performance with small training data sets) that satisfy both of the limitations above.

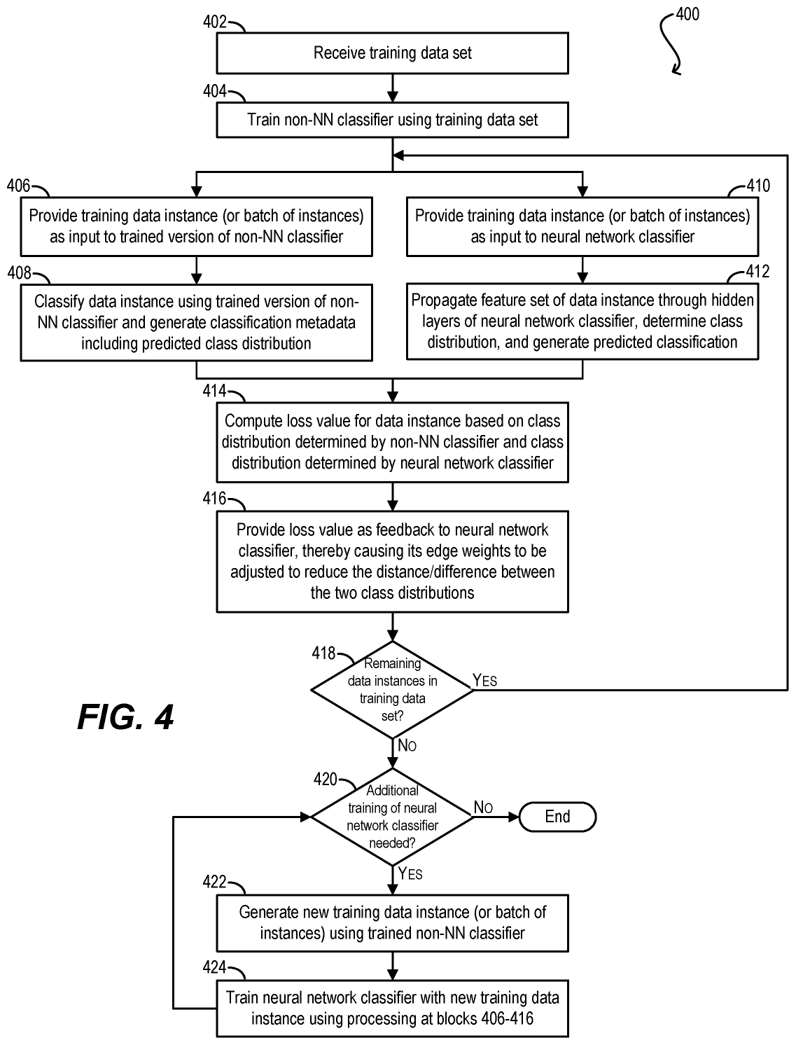

The remaining sections of the present disclosure present flowcharts for implementing training process 200 of FIG. 2 according to certain embodiments. It should be appreciated that FIG. 2 is illustrative and not intended to limit embodiments of the present disclosure. For example, as described with respect to FIG. 4 below, in some embodiments trained non-NN classifier M₂ can be employed to generate brand new labeled data instances and these new labeled data instances may be used (in addition to the existing labeled data instances in training data set X) for training neural network classifier M₁ in accordance with process 200. This approach is useful because (1) neural network classifiers generally require a large amount of training data to achieve high accuracy, and (2) the goal of training neural network classifier M₁ in FIG. 2 is to have M₁ behave like trained non-NN classifier M₂. Thus, by creating new labeled data instances via trained M₂ and providing those new data instances to neural network classifier M₁, M₁ is provided with a large volume of exactly the training data it needs in order to accurately mimic the classification behavior of M₂.

Further, although FIG. 2 assumes that neural network classifier M₁ is trained on a per-data instance basis (e.g., steps (3)-(9) are performed iteratively for each data instance i in training data set X), in some embodiments M₁ may be trained on batches of data instances at a time. Such batch-based processing may result in more efficient adjustment of the per-edge weights of neural network classifier M₁ at step (10) of process 200.

### 3. Workflows

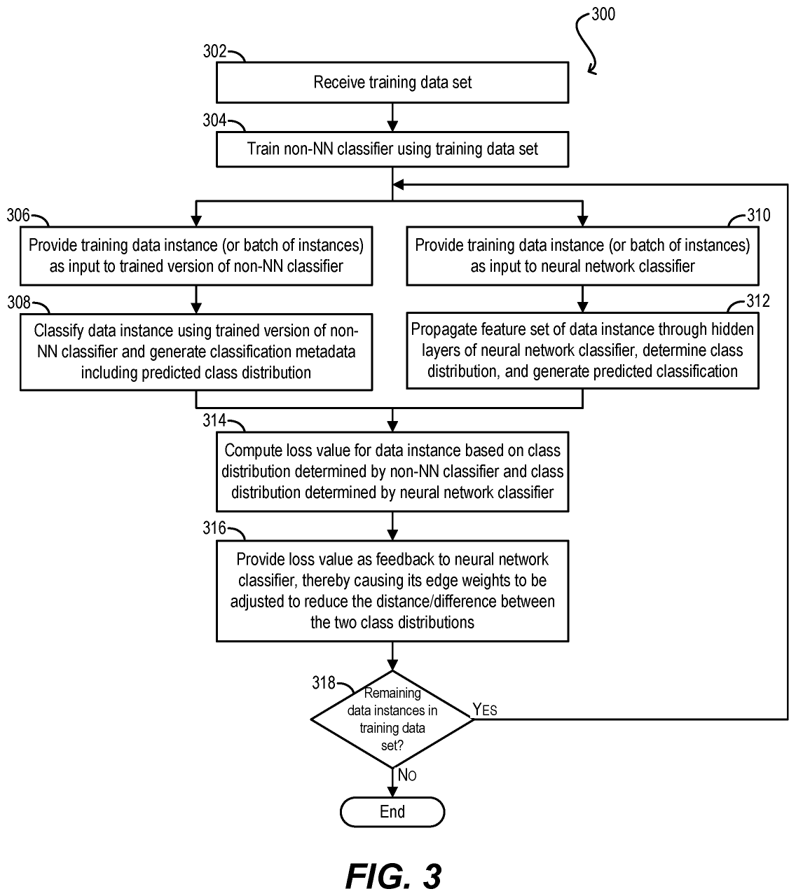

FIG. 3 is a workflow 300 that presents, in flowchart form, training process 200 of FIG. 2 according to certain embodiments. As used herein, a “workflow” is a series of actions or steps that can be taken by one or more entities. For purposes of explanation, it is assumed that workflow 300 is performed by a single physical or virtual computing device/system, such as a server in a cloud deployment, a user-operated client device, an edge device in an edge computing network, etc. However, in alternative embodiments different portions of the workflow may be performed by different computing devices/systems.

Starting with blocks 302 and 304, a computing device/system can receive a training data set (e.g., training data set X of FIG. 2) and train a non-NN classifier (e.g., classifier M₂ of FIG. 2) using the training data set. As mentioned previously, this non-NN classifier may be a random forest classifier, a boosting method classifier, etc. The result of the training at block 304 is a trained version of the non-NN classifier.

At blocks 306 and 308, the computing device/system can provide a data instance (or batch of data instances) in the training data set as input to the trained non-NN classifier and the trained non-NN classifier can classify the data instance. As part of block 308, the trained non-NN classifier can generate classification metadata that includes a class distribution indicating a predicted probability for each possible class to which the data instance may be categorized.

For example, assume there are three possible classes C1, C2, and C3. In this case, the metadata generated at block 308 for the data instance may include a class distribution (C1:0.7, C2:0.1, C3:0.2) which indicates that the trained non-NN classifier believes the data instance belongs to class C1 with a probability of 0.7 (or 70%), to class C2 with a probability of 0.1 (or 10%), and to class C3 with a probability of 0.2 (or 20%).

In parallel with blocks 306 and 308, the computing device/system can provide the same data instance (or same batch of data instances) noted in block 306 as input to a neural network classifier (e.g., classifier M₁ of FIG. 2) (block 310). In response, the neural network classifier can propagate the feature set of the data instance through its hidden layers, determine a class distribution for the data instance, and output a predicted classification for the data instance based on the class distribution (block 312).

Once the neural network classifier has output the predicted classification, the computing device/system can compute a loss value based on the metadata/class distribution determined by the trained non-NN classifier at block 308 and the class distribution determined by the neural network classifier at block 312 (block 314). As noted previously, this computation can involve calculating a loss function or a distance metric between these two distributions.

The computing device/system can then provide the computed loss value as feedback to the neural network classifier, which can cause the neural network classifier to adjust its internal edge weights in order to reduce the distance/difference between the two class distributions (block 316).

Finally, at block 318, the computing device/system can check whether there any remaining data instances in the training data set. If the answer is yes, the computing device/system can return to blocks 306/310 in order to process those further data instances in accordance with the subsequent steps as described above. Otherwise workflow 300 can end.

FIG. 4 depicts a training workflow 400 that is similar to workflow 300 of FIG. 3, but includes additional steps for generating brand new training (i.e., labeled) data instances via the trained version of the non-NN classifier and applying those new training data instances to further train the neural network classifier.

Blocks 402-416 are substantially the same as blocks 302-316 of workflow 300. At block 418, the computing device/system can check whether there any remaining data instances in the training data set. If the answer is yes, the computing device/system can return to blocks 406/410 in order to process those further data instances. However, if the answer at block 418 is no, the computing device/system can further check whether additional training for the neural network classifier is needed (block 420). This check can be based on, e.g., whether the neural network classifier has been trained using a sufficient threshold number of data instances or some other criteria.

If no further training of the neural network classifier is needed at block 420, workflow 400 can end. However, if further training is needed, the computing device/system can generate a new training data instance (or batch of new training data instances) via the trained non-NN classifier (block 422). In a particular embodiment, this step can comprise selecting a random set of features for the new training data instance, classifying the data instance using the trained non-NN classifier, and using the predicted classification output by the trained non-NN classifier as the label for the data instance.

Upon generating the new training data instance, the computing device/system can train the neural network classifier with this data instance by applying the processing at blocks 406-416 (block 424). Finally, the computing device/system can return to block 420 and repeat blocks 420-424 until the neural network classifier is deemed to be sufficiently trained.

Certain embodiments described herein can employ various computer-implemented operations involving data stored in computer systems. For example, these operations can require physical manipulation of physical quantities—usually, though not necessarily, these quantities take the form of electrical or magnetic signals, where they (or representations of them) are capable of being stored, transferred, combined, compared, or otherwise manipulated. Such manipulations are often referred to in terms such as producing, identifying, determining, comparing, etc. Any operations described herein that form part of one or more embodiments can be useful machine operations.

Further, one or more embodiments can relate to a device or an apparatus for performing the foregoing operations. The apparatus can be specially constructed for specific required purposes, or it can be a generic computer system comprising one or more general purpose processors (e.g., Intel or AMD x86 processors) selectively activated or configured by program code stored in the computer system. In particular, various generic computer systems may be used with computer programs written in accordance with the teachings herein, or it may be more convenient to construct a more specialized apparatus to perform the required operations. The various embodiments described herein can be practiced with other computer system configurations including handheld devices, microprocessor systems, microprocessor-based or programmable consumer electronics, minicomputers, mainframe computers, and the like.

Yet further, one or more embodiments can be implemented as one or more computer programs or as one or more computer program modules embodied in one or more non-transitory computer readable storage media. The term non-transitory computer readable storage medium refers to any data storage device that can store data which can thereafter be input to a computer system. The non-transitory computer readable media may be based on any existing or subsequently developed technology for embodying computer programs in a manner that enables them to be read by a computer system. Examples of non-transitory computer readable media include a hard drive, network attached storage (NAS), read-only memory, random-access memory, flash-based nonvolatile memory (e.g., a flash memory card or a solid state disk), a CD (Compact Disc) (e.g., CD-ROM, CD-R, CD-RW, etc.), a DVD (Digital Versatile Disc), a magnetic tape, and other optical and non-optical data storage devices. The non-transitory computer readable media can also be distributed over a network coupled computer system so that the computer readable code is stored and executed in a distributed fashion.

Finally, boundaries between various components, operations, and data stores are somewhat arbitrary, and particular operations are illustrated in the context of specific illustrative configurations. Other allocations of functionality are envisioned and may fall within the scope of the invention(s). In general, structures and functionality presented as separate components in exemplary configurations can be implemented as a combined structure or component. Similarly, structures and functionality presented as a single component can be implemented as separate components.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The above description illustrates various embodiments along with examples of how aspects of particular embodiments may be implemented. These examples and embodiments should not be deemed to be the only embodiments, and are presented to illustrate the flexibility and advantages of particular embodiments as defined by the following claims. Other arrangements, embodiments, implementations and equivalents can be employed without departing from the scope hereof as defined by the claims.

What is claimed is:

1. A method comprising:
training, by a computer system, a non-neural network classifier using a training data set, wherein the training data set comprises a plurality of data instances, wherein each data instance includes a feature set and a corresponding class label, and wherein the training results in a trained version of the non-neural network classifier;
classifying, by the computer system, a data instance in the plurality of data instances using the trained version of the non-neural network classifier, the classifying generating a first class distribution for the data instance;
providing, by the computer system, the data instance's feature set as input to a neural network classifier, the providing causing the neural network classifier to generate a second class distribution for the data instance;
computing, by the computer system, a loss value indicating a degree of divergence between the first class distribution and the second class distribution; and
providing, by the computer system, the loss value as feedback to the neural network classifier, the providing of the loss value as feedback causing the neural network classifier to adjust one or more internal edge weights in an manner that reduces the degree of divergence between the first class distribution and the second class distribution.

2. The method of claim 1 wherein computing the loss value comprises:
calculating a loss function or a distance metric between the first class distribution and the second class distribution.

3. The method of claim 1 wherein the classifying of the data instance using the trained version of the non-neural network classifier and the providing of the data instance's feature set as input to the neural network classifier are performed in parallel.

4. The method of claim 1 wherein the non-neural network classifier is a random forest classifier, and wherein the steps of claim 1 result in a version of the neural network classifier that incorporates properties of the random forest classifier.

5. The method of claim 1 further comprising:
generating a new training data instance using the trained version of the non-neural network classifier.

6. The method of claim 5 wherein generating the new training data instance comprises:
selecting a random feature set for the new training data instance;
classifying the new training data instance via the trained version of the non-neural network classifier, the classifying of the new training data instance resulting in a predicted classification; and
setting the predicted classification as a class label for the new training data instance.

7. The method of claim 5 further comprising:
classifying the new training data instance using the trained version of the non-neural network classifier, the classifying generating a first class distribution for the new training data instance;
providing the new training data instance's feature set as input to the neural network classifier, the providing causing the neural network classifier to generate a second class distribution for the new training data instance;
computing another loss value indicating a degree of divergence between the first class distribution for the new training data instance and the second class distribution for the new training data instance; and
providing said another loss value as feedback to the neural network classifier, the providing of said another loss value as feedback causing the neural network classifier to adjust one or more internal edge weights in an manner that reduces the degree of divergence between the first class distribution for the new training data instance and the second class distribution for the new training data instance.

8. A non-transitory computer readable storage medium having stored thereon program code executable by a computer system, the program code causing the computer system to execute a method comprising:
training a non-neural network classifier using a training data set, wherein the training data set comprises a plurality of data instances, wherein each data instance includes a feature set and a corresponding class label, and wherein the training results in a trained version of the non-neural network classifier;
classifying a data instance in the plurality of data instances using the trained version of the non-neural network classifier, the classifying generating a first class distribution for the data instance;
providing the data instance's feature set as input to a neural network classifier, the providing causing the neural network classifier to generate a second class distribution for the data instance;
computing a loss value indicating a degree of divergence between the first class distribution and the second class distribution; and
providing the loss value as feedback to the neural network classifier, the providing of the loss value as feedback causing the neural network classifier to adjust one or more internal edge weights in an manner that reduces the degree of divergence between the first class distribution and the second class distribution.

9. The non-transitory computer readable storage medium of claim 8 wherein computing the loss value comprises:
calculating a loss function or a distance metric between the first class distribution and the second class distribution.

10. The non-transitory computer readable storage medium of claim 8 wherein the classifying of the data instance using the trained version of the non-neural network classifier and the providing of the data instance's feature set as input to the neural network classifier are performed in parallel.

11. The non-transitory computer readable storage medium of claim 8 wherein the non-neural network classifier is a random forest classifier, and wherein the method of claim 8 results in a version of the neural network classifier that incorporates properties of the random forest classifier.

12. The non-transitory computer readable storage medium of claim 8 wherein the method further comprises:
generating a new training data instance using the trained version of the non-neural network classifier.

13. The non-transitory computer readable storage medium of claim 12 wherein generating the new training data instance comprises:
selecting a random feature set for the new training data instance;
classifying the new training data instance via the trained version of the non-neural network classifier, the classifying of the new training data instance resulting in a predicted classification; and
setting the predicted classification as a class label for the new training data instance.

14. The non-transitory computer readable storage medium of claim 12 wherein the method further comprises:
classifying the new training data instance using the trained version of the non-neural network classifier, the classifying generating a first class distribution for the new training data instance;
providing the new training data instance's feature set as input to the neural network classifier, the providing causing the neural network classifier to generate a second class distribution for the new training data instance;
computing another loss value indicating a degree of divergence between the first class distribution for the new training data instance and the second class distribution for the new training data instance; and
providing said another loss value as feedback to the neural network classifier, the providing of said another loss value as feedback causing the neural network classifier to adjust one or more internal edge weights in an manner that reduces the degree of divergence between the first class distribution for the new training data instance and the second class distribution for the new training data instance.

15. A computer system comprising:
a processor; and
a non-transitory computer readable medium having stored thereon program code that, when executed, causes the processor to:
train a non-neural network classifier using a training data set, wherein the training data set comprises a plurality of data instances, wherein each data instance includes a feature set and a corresponding class label, and wherein the training results in a trained version of the non-neural network classifier;
classify a data instance in the plurality of data instances using the trained version of the non-neural network classifier, the classifying generating a first class distribution for the data instance;
provide the data instance's feature set as input to a neural network classifier, the providing causing the neural network classifier to generate a second class distribution for the data instance;
compute a loss value indicating a degree of divergence between the first class distribution and the second class distribution; and
provide the loss value as feedback to the neural network classifier, the providing of the loss value as feedback causing the neural network classifier to adjust one or more internal edge weights in an manner that reduces the degree of divergence between the first class distribution and the second class distribution.

16. The computer system of claim 15 wherein the program code that causes the processor to compute the loss value comprises program code that causes the processor to:
calculate a loss function or a distance metric between the first class distribution and the second class distribution.

17. The computer system of claim 15 wherein the classifying of the data instance using the trained version of the non-neural network classifier and the providing of the data instance's feature set as input to the neural network classifier are performed in parallel.

18. The computer system of claim 15 wherein the non-neural network classifier is a random forest classifier, and wherein the steps performed by the processor result in a version of the neural network classifier that incorporates properties of the random forest classifier.

19. The computer system of claim 15 wherein the program code further causes the processor to:
generate a new training data instance using the trained version of the non-neural network classifier.

20. The computer system of claim 19 wherein the program code that causes the processor to generate the new training data instance comprises program code that causes the processor to:
select a random feature set for the new training data instance;
classify the new training data instance via the trained version of the non-neural network classifier, the classifying of the new training data instance resulting in a predicted classification; and
set the predicted classification as a class label for the new training data instance.

21. The computer system of claim 19 wherein the program code further causes the processor to:
classify the new training data instance using the trained version of the non-neural network classifier, the classifying generating a first class distribution for the new training data instance;
provide the new training data instance's feature set as input to the neural network classifier, the providing causing the neural network classifier to generate a second class distribution for the new training data instance;
compute another loss value indicating a degree of divergence between the first class distribution for the new training data instance and the second class distribution for the new training data instance; and
provide said another loss value as feedback to the neural network classifier, the providing of said another loss value as feedback causing the neural network classifier to adjust one or more internal edge weights in an manner that reduces the degree of divergence between the first class distribution for the new training data instance and the second class distribution for the new training data instance.
